(19) United States
(12) Patent Application Publication
(10) Pub. No.: US 2023/0097134 A1
(43) Pub. Date: Mar. 30, 2023

(54) PLANT PROTEIN-FURFURYL ALCOHOL WOOD ADHESIVE AND PREPARATION METHOD THEREOF

(71) Applicant: Southwest Forestry University, Kunming City (CN)

(72) Inventors: Xiaojian Zhou, Kunming City (CN); Xinyi Chen, Kunming City (CN); Guanben Du, Kunming City (CN); Zhengyong Yang, Kunming City (CN); Fuxian Yang, Kunming City (CN); Haizhu Wu, Kunming City (CN)

(21) Appl. No.: 17/568,085

(22) Filed: Jan. 4, 2022

(30) Foreign Application Priority Data
Sep. 27, 2021 (CN) 202111137427.2

(51) Int. Cl. C09J 189/00; C08K 5/1535; C08K 5/07

(52) U.S. Cl. CPC C09J 189/00; C08K 5/1535; C08K 5/07

(57) ABSTRACT

A plant protein-furfuryl alcohol wood adhesive and a preparation method thereof are disclosed. The adhesive according to the disclosure is prepared from raw materials comprising, in parts by weight, 10 to 15 parts of a plant protein, 10 to 25 parts of furfuryl alcohol, 4 to 8 parts of water, 1 to 6 parts of a catalyst, and 0 to 20 parts of an additive.

### CROSS-REFERENCE TO RELATED APPLICATION

This patent application claims the benefit and priority of Chinese Patent Application No. 202111137427.2, filed on Sep. 27, 2021, the contents of which are incorporated by reference in their entirety as part of the present application.

### TECHNICAL FIELD

The present disclosure belongs to the technical field of adhesive preparation, and specifically relates to a plant protein-furfuryl alcohol wood adhesive and a preparation method thereof.

### BACKGROUND ART

At present, wood-based panels have an annual output exceeding 300 million cubic meters in China, and they are widely used in custom furniture, decoration and construction fields. The special “separation” and “adhesion” preparation process of wood-based panels could not be performed without adhesives. Adhesive technology is the key core technology for the preparation of wood-based panels. In other words, there is no wood-based panel without adhesives. The adhesives used in the preparation of wood-based panels have an annual output exceeding 15 million tons in China, more than 90% of which are formaldehyde resin adhesives, which have the characteristics of formaldehyde release and non-renewable raw materials. Therefore, it is urgent to make full use of biomass raw materials and carry out research on environmentally friendly biomass resin wood adhesives. Researchers have successfully developed new environmentally friendly biomass resin adhesives such as protein adhesives, starch adhesives and tannin resin adhesives. There have been related studies on the furfuryl alcohol modified soy protein-based adhesive based on model compounds, but this method only focuses on the properties of the adhesive and studies a thermosetting adhesive. Further, the synthesis process is slightly complicated and needs to occur under high temperature, which increases a certain production cost.

Chinese patent application No. CN201710979162.8 discloses a plant protein adhesive, a preparation method and use thereof. The adhesive is prepared from the following raw materials in parts by mass: 10 to 40 parts of a plant protein and 20 to 60 parts of water, 5 to 25 parts of a crosslinking agent, 0.5 to 5 parts of an alkali, and 0.5 to 8 parts of an activator. Among them, the cross-linking agent is one or more selected from the group consisting of glucose-lignin resin cross-linking agent, urea-dialdehyde starch resin, and tannin-furfuryl alcohol resin; the plant protein is one or more selected from the group consisting of defatted soybean powder, defatted soybean meal, soybean protein isolate, defatted peanut powder, defatted cottonseed meal and defatted camellia meal powder; the glucose-lignin resin crosslinking agent is obtained by hydrolyzing an aqueous glucose solution in the presence of an acid catalyst, wherein the acid catalyst is one or more selected from the group consisting of sulfuric acid, nitric acid, halogen acid, and oxalic acid. The preparation method of the adhesive is performed as follows: (1) thermally mixing the plant protein, water, the activator and the alkali at a temperature of 80-90° C. to obtain a thermally mixed raw material; (2) subjecting the thermally mixed raw material to a cross-linking polymerization using a cross-linking agent at a polymerization temperature of 65-78° C. to obtain a plant protein adhesive. This technology also needs to prepare the adhesive at high temperature, and also needs to cure the adhesive at a temperature of 120-125° C. And, the key to this technology is the preparation of the cross-linking agent, which makes the process slightly complicated.

Chinese patent application No. CN201010603142.9 discloses a plywood produced by using a plant protein adhesive, which discloses a plant protein adhesive comprising the following raw materials in parts by weight: 100 parts of defatted soybean flour, 1000 parts of water, 25 to 35 parts of an alkaline solution, and 3 to 5 parts of an anionic surfactant. The preparation method of the adhesive is performed as follows: (1) adding water to a reactor, controlling a temperature at 25 to 35° C., starting stirring, then adding defatted soybean flour, continuously stirring to make the resulting mixture uniform; (2) adding the alkali solution, stirring and reacting for 20-30 minutes, stopping stirring, standing for 30 minutes and centrifuging with a centrifuge, then discarding a supernate to obtain a first sediment; (3) centrifuging the first sediment with a centrifuge, discarding a supernate to obtain a second sediment; (4) adding the anionic surfactant to the second sediment, and then adding a preservative after dissolution to obtain the adhesive. Although this technology could prepare the adhesive at ambient temperature, it requires multi-step centrifugal separation operation, making the process slightly complicated and increasing the cost, and it still needs to cure the adhesive at a high temperature of 105-110° C.

Hao Haixia et. al (“Effects of 3 treatments on Jatropha curcas Protein-Based Adhesive”, Journal of Southwest Forestry University, 2016.) studied the effect of sodium hydroxide-urea, calcium hydroxide/sodium hydroxide and sodium bisulfate treatment on the performance of Jatropha curcas protein-based adhesives. Although the adhesive in this document is prepared under ambient temperature, the adhesive is treated under an alkaline condition, during which high-cost cross-linking agents need to be added to achieve reinforcement, and it is still cured at high temperature, with no enlightenment for curing at ambient temperature.

### SUMMARY

In order to solve the above problems, the present disclosure provides a plant protein-furfuryl alcohol wood adhesive and a preparation method thereof.

Specifically, the present disclosure provides the following technical solutions:

1. A plant protein-furfuryl alcohol wood adhesive, which is prepared from raw materials comprising, in parts by weight, 10 to 15 parts of a plant protein, 10 to 25 parts of furfuryl alcohol, 4 to 8 parts of water, 1 to 6 parts of a catalyst, and 0 to 20 parts of an additive.

In some embodiments, the plant protein includes, but is not limited to, hydrolyzed wheat protein, hydrolyzed soybean protein, and hydrolyzed Jatropha curcas protein.

In some embodiments, the plant protein has a protein content of 70%-90%, and a total content of starch and sugar of 4%-8%.

In some embodiments, the catalyst is an acid catalyst.

In some embodiments, the acid catalyst includes, but is not limited to, p-toluenesulfonic acid (pTSA), hydrochloric acid, 2-chloroacetic acid, 2-bromoacetic acid, and nitrous acid.

In some embodiments, the additive is one selected from the group consisting of formaldehyde, glyoxal, glutaraldehyde, epoxy resin, branched amine, and isocyanate.

2. When the above plant protein-furfuryl alcohol wood adhesive is used for thermal curing, its preparation method comprises the following steps:

(1) stirring the plant protein, furfuryl alcohol and water at ambient temperature for 5-10 min to be uniform to obtain a mixture; and

(2) adding the catalyst into the mixture, and stirring to be uniform to obtain the adhesive for later use.

3. When the above plant protein-furfuryl alcohol wood adhesive is used for curing at ambient temperature, its preparation method includes the following steps:

(1) stirring the plant protein, furfuryl alcohol and water at ambient temperature for 5-10 min to be uniform to obtain a mixture; and

(2) adding the catalyst and the additive into the mixture, and stirring to be uniform to obtain the adhesive for later use.

4. The application method of the above plant protein-furfuryl alcohol wood adhesive is as follows:

(1) when used for pressing a plywood, the adhesive is cured at a high temperature for use.

(2) when used for pressing a glulam and cross-laminated timber, the adhesive is cured at ambient temperature for use.

In summary, the present disclosure has the following beneficial effects: in the present disclosure, an acid catalyst and an additive are used to treat the plant protein, which allows the condensation polymerization of the protein and furfuryl alcohol and the self-condensation of furfuryl alcohol to occur simultaneously, and makes it possible to prepare the adhesive and quickly cure the same at ambient temperature, thus greatly improving the efficiency of preparation and use, and reducing the production cost.

In the present disclosure, the copolycondensation of the plant protein and furfuryl alcohol and the self-condensation of furfuryl alcohol could occur under an acidic condition, and the synthesis and preparation process could be completed at ambient temperature. The adhesive is prepared from raw materials with a high proportion of biomass raw materials, reaching more than 95%, and is highly renewable. In addition, compared with the existing adhesive preparation method, the adhesive prepared by the method according to the present disclosure could be cured at ambient temperature or high temperature according to different requirements. The wood materials such as plywoods, glulam and cross-laminated timber prepared by using the adhesive have mechanical properties meeting the requirements of China's standards.

### DETAILED DESCRIPTION OF THE EMBODIMENTS

The specific embodiments of the present disclosure will be described in further detail below, but the present disclosure is not limited to these embodiments. Any improvement or substitution in the basic spirit of the embodiment still falls within the scope claimed by the claims of the present disclosure.

### Hot Pressing

### Example 1 (Thermal Curing)

12 parts of hydrolyzed wheat protein, 10 parts of furfuryl alcohol and 6 parts of water were stirred at ambient temperature for 5-10 minutes to be uniform, obtaining a mixture. 3 parts of a p-toluenesulfonic acid solution (with a concentration of 65%) was added into the mixture and stirred to be uniform, obtaining an adhesive. The adhesive was evenly spread on the upper and lower surfaces of the core layer of a poplar wood veneer, with a double-sided spreading amount of the adhesive being 260 g/m², to prepare a three-layer plywood. The three-layer plywood was subjected to a hot pressing according to a plywood hot pressing process at a temperature of 180° C. and a unit pressure of 1.5 MPa for 7 min.

### Example 2 (Thermal Curing)

12 parts of hydrolyzed wheat protein, 10 parts of furfuryl alcohol and 6 parts of water were stirred at ambient temperature for 5-10 minutes to be uniform, obtaining a mixture. 3 parts of a p-toluenesulfonic acid solution (with a concentration of 65%) was added into the mixture and stirred to be uniform, obtaining an adhesive. The adhesive was evenly spread on the upper and lower surfaces of the core layer of a poplar wood veneer, with a double-sided spreading amount of the adhesive being 240 g/m², to prepare a three-layer plywood. The three-layer plywood was subjected to a hot pressing according to a plywood hot pressing process at a temperature of 140° C. and a unit pressure of 1.5 MPa for 6 min.

### Example 3 (Thermal Curing)

12 parts of hydrolyzed wheat protein, 10 parts of furfuryl alcohol and 6 parts of water were stirred at ambient temperature for 5-10 minutes to be uniform, obtaining a mixture. 2 parts of a p-toluenesulfonic acid solution (with a concentration of 65%) was added into the mixture and stirred to be uniform, obtaining an adhesive. The adhesive was evenly spread on the upper and lower surfaces of the core layer of a poplar wood veneer, with a double-sided spreading amount of the adhesive being 240 g/m², to prepare a three-layer plywood. The three-layer plywood was subjected to a hot pressing according to a plywood hot pressing process at a temperature of 180° C. and a unit pressure of 1.5 MPa for 6 min.

### Example 4 (Thermal Curing)

12 parts of hydrolyzed soybean protein, 10 parts of furfuryl alcohol and 6 parts of water were stirred at ambient temperature for 5-10 minutes to be uniform, obtaining a mixture. 3 parts of a p-toluenesulfonic acid solution (with a concentration of 65%) was added into the mixture and stirred to be uniform, obtaining an adhesive. The adhesive was evenly spread on the upper and lower surfaces of the core layer of a poplar wood veneer, with a double-sided spreading amount of the adhesive being 260 g/m², to prepare a three-layer plywood. The three-layer plywood was subjected to a hot pressing according to a plywood hot pressing process at a temperature of 180° C. and a unit pressure of 1.5 MPa for 7 min.

### Example 5 (Thermal Curing)

12 parts of hydrolyzed Jatropha curcas protein, 10 parts of furfuryl alcohol and 6 parts of water were stirred at ambient temperature for 5-10 minutes to be uniform, obtaining a mixture. 3 parts of a hydrochloric acid aqueous solution (with a concentration of 10%) was added into the mixture and stirred to be uniform, obtaining an adhesive. The adhesive was evenly spread on the upper and lower surfaces of the core layer of a poplar wood veneer, with a double-sided spreading amount of the adhesive being 260 g/m², to prepare a three-layer plywood. The three-layer plywood was subjected to a hot pressing according to a plywood heat pressing process at a temperature of 180° C. and a unit pressure of 1.5 MPa for 7 min.

### Comparative Example 1 (Thermal Curing)

10 parts of furfuryl alcohol and 6 parts of water were stirred at ambient temperature for 5-10 minutes to be uniform, obtaining a mixture. 2 parts of p-toluenesulfonic acid solution (with a concentration of 65%) was added in the mixture and stirred to be uniform, obtaining an adhesive. The adhesive was evenly spread on the upper and lower surfaces of the core layer of a poplar wood veneer, with a double-sided spreading amount of the adhesive being 240 g/m², to prepare a three-layer plywood. The three-layer plywood was subjected to a hot pressing according to a plywood heat pressing process at a temperature of 180° C. and a unit pressure of 1.5 MPa for 6 min.

### Comparative Example 2 (Thermal Curing)

12 parts of hydrolyzed wheat protein and 6 parts of water were stirred at ambient temperature. In the actual operation process, the operation is difficult due to a high viscosity, which makes it difficult to achieve its uniformity. 2 parts of p-toluenesulfonic acid solution (with a concentration of 65%) was added thereto, and stirred as much as possible. The prepared adhesive was evenly spread on the upper and lower surfaces of the core layer of a poplar wood veneer, with a double-sided spreading amount of the adhesive being 240 g/m² to prepare a three-layer plywood. The three-layer plywood was subjected to a hot pressing according to a plywood hot pressing process at a temperature of 180° C. and a unit pressure of 1.5 MPa for 6 min.

### Cold Pressing

### Example 6 (Cold Curing)

12 parts of hydrolyzed wheat protein, 24 parts of furfuryl alcohol and 8 parts of water were stirred at ambient temperature for 5-10 minutes to be uniform, obtaining a mixture. 6 parts of p-toluenesulfonic acid solution (with a concentration of 65%) was added into the mixture, and stirred to be uniform, obtaining an adhesive for later use. Before spreading, 16 parts of a glyoxal solution with a concentration of 40% was added to the adhesive. The final prepared adhesive was evenly spread on two surfaces of a rubber wood, with a double-sided spreading amount of the adhesive being 240 g/m² to prepare a glulam sample. The glulam sample was then subjected to a cold pressing according to a cold pressing process at a unit pressure of 1.5 MPa for 6 h.

### Example 7 (Cold Curing)

12 parts of hydrolyzed soybean protein, 24 parts of furfuryl alcohol and 8 parts of water were stirred at ambient temperature for 5-10 minutes to be uniform, obtaining a mixture. 4 parts of a hydrochloric acid aqueous solution (with a concentration of 10%) was added thereto, and stirred to be uniform, obtaining an adhesive for later use. Before spreading, 10 parts of glutaraldehyde solution with a concentration of 50% was added to the adhesive. The final prepared adhesive was evenly spread on two surfaces of a rubber wood with a double-sided spreading amount of the adhesive being 240 g/m², obtaining a glulam sample. The glulam sample was then subjected to a cold pressing according to the cold pressing process at ambient temperature and a unit pressure of 1.5 MPa for 6 h.

### Comparative Example 3 (Cold Curing)

12 parts of hydrolyzed wheat protein, 24 parts of furfuryl alcohol and 8 parts of water were stirred at ambient temperature for 5-10 minutes to be uniform, obtaining a mixture. 6 parts of p-toluenesulfonic acid solution (with a concentration of 65%) was added into the mixture, and stirred to be uniform, obtaining an adhesive for later use. Without adding any additives, the adhesive was directly evenly spread on two surfaces of a rubber wood, with a double-sided spreading amount of the adhesive being 240 g/m² to prepare a glulam sample. The glulam sample was subjected to a cold pressing according to a cold pressing process at a unit pressure of 1.5 MPa for 6 h.

The hot pressed plywoods and cold pressed glulams obtained in all the examples and comparative examples were subjected to a shear strength test, respectively. The results of the shear strength test for the hot pressed plywoods are shown in Table 1, and the results of the shear strength for the cold pressed glulams are shown in Table 2.

TABLE 1

| | Shear strength | Shear strength | Shear strength |
|---|---|---|---|
| | (cold water, | (63° C., | (boiling water, |
| Examples | 24 h)/MPa | 3 h)/MPa | 3 h)/MPa |
| Example 1 | 1.02 | 1.00 | 1.42 |
| Example 2 | 0.46 | — | — |
| Example 3 | 0.54 | 0.67 | 0.46 |
| Example 4 | 1.00 | 0.97 | 0.95 |
| Example 5 | 0.95 | 0.87 | 0.87 |
| Comparative | — | — | — |
| Example 1 | | | |
| Comparative | — | — | — |
| Example 2 | | | |

Notes:
“—” means that the sample has been degummed and failed during the soaking process.

It can be seen from Table 1 that the effect difference between Examples 1 and 2 is due to the great influence of a plywood hot pressing process on the performance of the panel. Through additional orthogonal experiments, it is concluded that the spreading amount of adhesives and the hot pressing temperature have a greater impact on the performance of the panel. The product of Example 1 has a high shear strength, and still has bonding strength far beyond the requirements of the standards after soaking in boiling water for 3 hours. It can be seen from Example 3 that the addition of pTSA (i.e., the pH) has a significant effect on the curing of the adhesive, and the reduction of the amount of acid leads to an uncomplete crosslinking of the adhesive, thereby resulting in a substandard shear strength. It can be determined from Examples 4 and 5 that all plywoods prepared from different plant proteins and adhesives synthesized in the presence of different acids have performance meeting the requirements of China's standards. Both the plywoods prepared by the separately prepared furfuryl alcohol adhesive (Comparative Example 1) and wheat protein adhesive (Comparative Example 2) have performance not meeting the China's standards, and are generally degummed and failed during the soaking process.

TABLE 2

| | Shear strength | Shear strength |
|---|---|---|
| | (dry condition)/ | (63° C., |
| Examples | MPa | 3 h)/MPa |
| Example 6 | 7.25 | 6.80 |
| Example 7 | 6.57 | 6.52 |
| Comparative | 1.2 | 1.8 |
| Example 3 | | |

It can be seen from Examples 6 and 7, whether hydrolyzed wheat protein or hydrolyzed soybean protein is used, the adhesive prepared with glyoxal or glutaraldehyde as the crosslinking agent has a good cold pressing effect, and the glulam has a strength meeting the requirements of the standards. It can be seen from the results of the Comparative Example 3, without the addition of an additive, the adhesive has a poor cold pressing effect on the panel, and the panel has a bonding strength not meeting the requirements of the standards.

What is claimed is:

1. A plant protein-furfuryl alcohol wood adhesive, which is prepared from raw materials comprising, in parts by weight, 10 to 15 parts of a plant protein, 10 to 25 parts of furfuryl alcohol, 4 to 8 parts of water, 1 to 6 parts of a catalyst, and 0 to 20 parts of an additive.

2. The plant protein-furfuryl alcohol wood adhesive of claim 1, wherein the plant protein is selected from the group consisting of hydrolyzed wheat protein, hydrolyzed soybean protein, and hydrolyzed Jatropha curcas protein, wherein the plant protein has a protein content of 70%-90%, and a total content of starch content and sugar content of 4%-8%.

3. The plant protein-furfuryl alcohol wood adhesive of claim 1, wherein the catalyst is an acid catalyst.

4. The plant protein-furfuryl alcohol wood adhesive of claim 3, wherein the acid catalyst is selected from the group consisting of p-toluenesulfonic acid, hydrochloric acid, 2-chloroacetic acid, 2-bromoacetic acid, and nitrous acid.

5. The plant protein-furfuryl alcohol wood adhesive of claim 1, wherein the additive is one or more selected from the group consisting of glyoxal, formaldehyde, glutaraldehyde, and furfural.

6. A method for preparing the plant protein-furfuryl alcohol wood adhesive of claim 1 for thermal curing, the method comprising:
(1) stirring the plant protein, the furfuryl alcohol, and the water at ambient temperature for 5-10 minutes to be uniform, thereby obtaining a mixture; and
(2) adding the catalyst into the mixture, and stirring to be uniform, thereby obtaining the plant protein-furfuryl alcohol wood adhesive, wherein the plant protein-furfuryl alcohol wood adhesive is applicable for the preparation of a hot-pressed plywood.

7. The method of claim 6, wherein the plant protein is selected from the group consisting of hydrolyzed wheat protein, hydrolyzed soybean protein, and hydrolyzed Jatropha curcas protein, wherein the plant protein has a protein content of 70%-90%, and a total content of starch content and sugar content of 4%-8%.

8. The method of claim 6, wherein the catalyst is an acid catalyst.

9. The method of claim 8, wherein the acid catalyst is selected from the group consisting of p-toluenesulfonic acid, hydrochloric acid, 2-chloroacetic acid, 2-bromoacetic acid, and nitrous acid.

10. A method for preparing the plant protein-furfuryl alcohol wood adhesive of claim 1 for cold-pressing curing, the method comprising:
(1) stirring the plant protein, the furfuryl alcohol, and the water at ambient temperature for 5-10 minutes to be uniform, thereby obtaining a mixture; and
(2) adding the catalyst and the additive into the mixture, and stirring to be uniform, thereby obtaining the plant protein-furfuryl alcohol wood adhesive.

11. The method of claim 10, wherein the plant protein is selected from the group consisting of hydrolyzed wheat protein, hydrolyzed soybean protein, and hydrolyzed Jatropha curcas protein, wherein the plant protein has a protein content of 70%-90%, and a total content of starch content and sugar content of 4%-8%.

12. The method of claim 10, wherein the catalyst is an acid catalyst.

13. The method of claim 12, wherein the acid catalyst is selected from the group consisting of p-toluenesulfonic acid, hydrochloric acid, 2-chloroacetic acid, 2-bromoacetic acid, and nitrous acid.

14. The method of claim 10, wherein the additive is one or more selected from the group consisting of glyoxal, formaldehyde, glutaraldehyde, and furfural.
